(19) United States
(12) Patent Application Publication
(10) Pub. No.: US 2010/0194792 A1
(43) Pub. Date: Aug. 5, 2010

(54) ILLUMINATION UNIT AND METHOD FOR DRIVING THE ILLUMINATION UNIT

(75) Inventors: Bakuri Lanchava, Regensburg (DE); Robert Kraus, Regensburg (DE); David Dussault, Neutraubling (DE); Matthias Fiegler, Oberhaching (DE); Ralph Bertram, Nittendorf (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/678,746

(22) PCT Filed: Sep. 18, 2008
(86) PCT No.: PCT/EP08/07824

§ 371 Date: Mar. 18, 2010

(30) Foreign Application Priority Data
Sep. 18, 2007 (DE) 10 2007 044 476.3

(51) Int. Cl. G09G 5/10; H05B 39/00; H05B 37/02; H05B 41/16

(52) U.S. Cl. 345/691; 315/312; 315/294; 315/250; 345/84

(57) ABSTRACT

An illumination unit may include at least one luminous means; a detector, which is configured to be used to detect at least one brightness of an image; at least one controller connected to the at least one luminous means and to the detector, wherein the at least one luminous means can be driven in a manner dependent on the at least one brightness of the image with the aid of the controller; a plurality of luminous means whose brightnesses can be set in each case at least one of individually and in clusters with the aid of the controller; and at least one switch which is configured to be used to short-circuit at least one luminous means.

The invention relates to an illumination unit and a method for driving the illumination unit.

It is known to set (to dim) the brightness of light emitting diodes (LEDs) by means of pulse width modulation (PWM). In this case, the dimming of the LEDs has the advantage that the latter can be operated with their desired current.

However, this type of brightness regulation leads to so-called stroboscope effects, which become visible to an observer if light source and eye of the observer move relative to one another.

This problem has been solved with the aid of constant current regulation of the LEDs. However, this approach has the disadvantage that a high contrast, particularly in a low brightness range, is not possible since different LEDs generally have different current switching levels. Furthermore, the luminous efficiency of the opto-semiconductors in a low current range can be set or controlled only with difficulty.

An illumination device for backlighting displays is described in WO 2004/031844 A1. Said illumination device comprises, for generating light with a white color impression, different colored light sources arranged in such a way that mixed-colored light is emitted from the front side of the illumination device.

In this case, it is disadvantageous that the emission characteristic of the illumination devices is highly inhomogeneous with regard to color and brightness.

The object of the invention consists in avoiding the disadvantages mentioned above, and in particular in specifying a back light unit (BLU), which enables energy-efficient operation and can be used for LCD televisions, for example.

This object is achieved in accordance with the features of the independent patent claims. Developments of the invention also emerge from the dependent claims.

In order to achieve the object, an illumination unit is specified, including:
at least one luminous means,
a detection unit, which can be used to detect at least one brightness of an image;
at least one control unit connected to the at least one luminous means and to the detection unit, wherein the at least one luminous means can be driven in a manner dependent on the at least one brightness of the image with the aid of the control unit;
a plurality of luminous means whose brightnesses can be set in each case individually and/or in clusters with the aid of the control unit;
at least one switch which can be used to short-circuit at least one luminous means.

One development consists in the fact that the detection unit can be used to detect at least one brightness, in particular a plurality of brightnesses of the image.

This approach advantageously enables an illumination device having an extended functionality for an improved time- and/or location-dependent illumination regulation.

In one development, the at least one luminous means includes a light emitting diode.

In another development, the at least one luminous means comprises a plurality of clusters, wherein each cluster includes one or a plurality of light emitting diodes.

In particular, in one development, the cluster has at least two green light emitting diodes, one blue light emitting diode and one red light emitting diode (“RGGB” cluster).

Moreover, in one development, the cluster is arranged in areal fashion.

In particular, the at least one cluster can be arranged in areal fashion over the image. Preferably, each light emitting diode and/or each cluster of light emitting diodes can be driven individually with the aid of the control unit.

Furthermore, in one development, the at least one luminous means is arranged on at least one substrate.

In the context of an additional development, the control unit includes at least one dimming device. In this case, it is possible that a brightness of the at least one luminous means can be set with the aid of the at least one dimming device.

It should be noted here that the dimming device can be embodied as part of the control unit and/or separately from the control unit.

A next development consists in the fact that the image is a video image, in particular an image of an LCD display.

In particular, the image can be a video image of an LCD television.

In one configuration, the control unit illuminates dark regions of the image more weakly than bright regions with the aid of the detection unit by means of the at least one luminous means.

As a result, it is possible that the illumination unit, preferably used as back light illumination or backlighting, enables a significant energy saving.

An alternative embodiment consists in the fact that the at least one luminous means includes light emitting diodes having different wavelengths.

As a result, it is possible, for example, to obtain back light illumination in virtually any desired hues.

In particular, such a switch is provided for each light emitting diode. Furthermore, the switch is preferably an electronic switch which can be activated by the control unit. Such a switch for the at least one luminous means can be dynamically activated or preconfigured (quasi-statically) according to particular user desires.

One development consists in the fact that brightnesses of the image can be set with the aid of the control unit by means of a pulse width modulation and/or a DC current regulation. In particular, it is possible that the brightness of the at least one luminous means can be set by means of the pulse width modulation and/or the DC current regulation.

Preferably, the DC current regulation can be used in a range of low brightness and the pulse width modulation can be used in a range of high brightness.

In an additional configuration, the detection unit comprises at least one Photosensor. In particular, the at least one Photosensor can be embodied in locally adjacent fashion with the at least one luminous means.

In another configuration, provision is made of at least one driver for driving the at least one luminous means. Preferably, provision can be made of a respective driver for driving a plurality of luminous means, in particular light emitting diodes, connected in series.

Moreover, in one possible option, barriers are provided between the image and the detection unit, said barriers being suitable for at least partly separating regions of different illumination.

Moreover, in a further configuration, the control unit acquires a video signal.

In this respect, in an advantageous manner, brightness information of the video signal can be evaluated (e.g. an average brightness or background brightness) and the at least one luminous means can be correspondingly driven on the basis of such an evaluation.

The object mentioned above is also achieved by means of a method for driving the illumination unit in accordance with the present description.

Furthermore, the object mentioned above is achieved on the basis of a method for driving an illumination unit, including the following steps:
detecting a brightness of an image;
driving at least one luminous means on the basis of the detected brightness, wherein at least one dark region of the image is illuminated more weakly than at least one bright region of the image with the aid of the at least one luminous means;
wherein provision is made of at least one switch which is used to short-circuit at least one luminous means.

One development consists in the fact that the at least one luminous means includes a light emitting diode. In particular, the at least one luminous means can include a plurality of clusters, wherein each cluster includes one or a plurality of light emitting diodes.

In another development, the cluster has at least two green light emitting diodes, one blue light emitting diode and one red light emitting diode.

Furthermore, it is possible that the at least one luminous means includes light emitting diodes having different wavelengths.

In one configuration, provision is made of a plurality of luminous means whose brightnesses is/are set individually and/or in clusters with the aid of the control unit.

Furthermore, in one configuration, the brightness of the at least one luminous means are set by means of a pulse width modulation and/or a DC current regulation.

In an advantageous manner, the DC current regulation can be used in a range of low brightness and/or the pulse width modulation can be used in a range of high brightness.

Moreover, in one development, the detection unit includes at least one photosensor.

An additional configuration consists in the fact that a video signal is applied to the control unit.

Exemplary embodiments of the invention are explained and illustrated below with reference to the drawings.

In the figures:

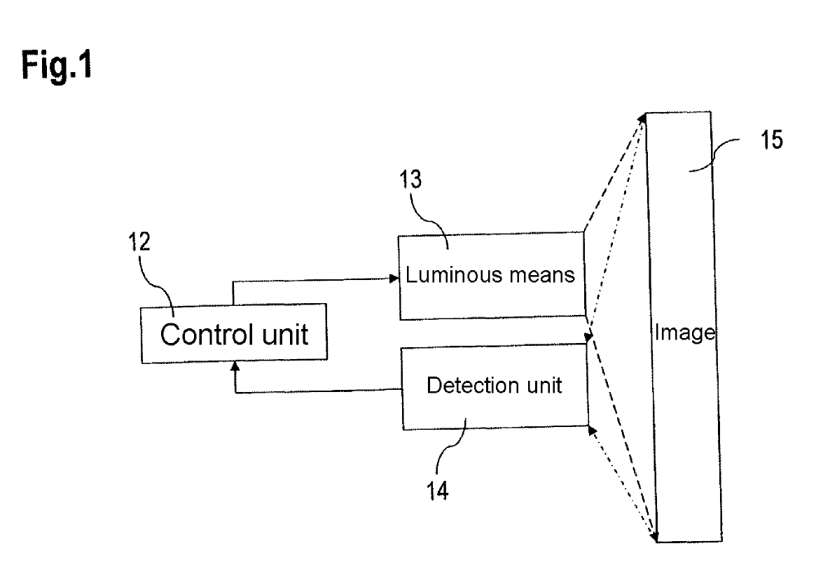

FIG. 1 shows a block diagram of an illumination unit, in particular a back light unit (BLU);

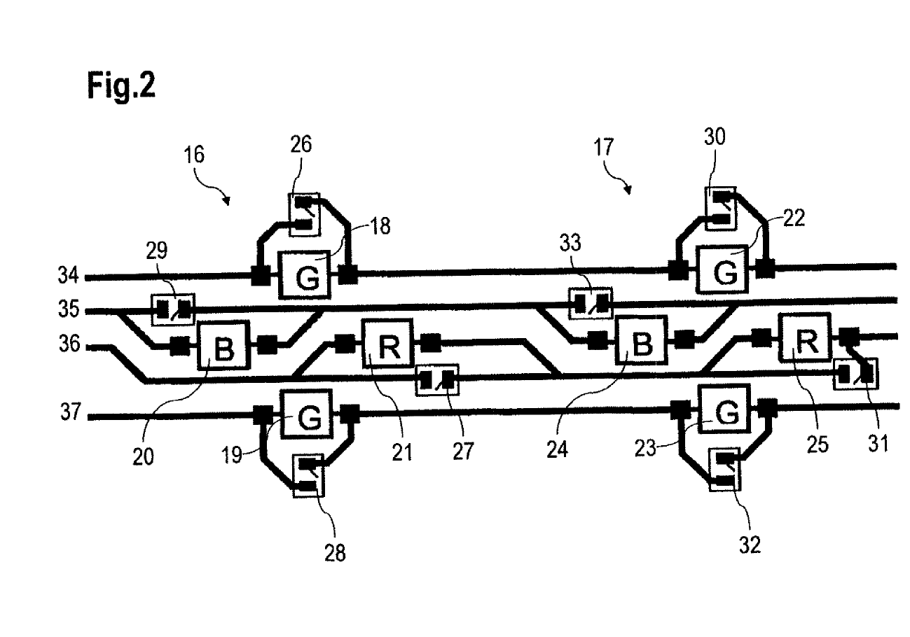

FIG. 2 shows two adjacent LED clusters (“RGGB” clusters);

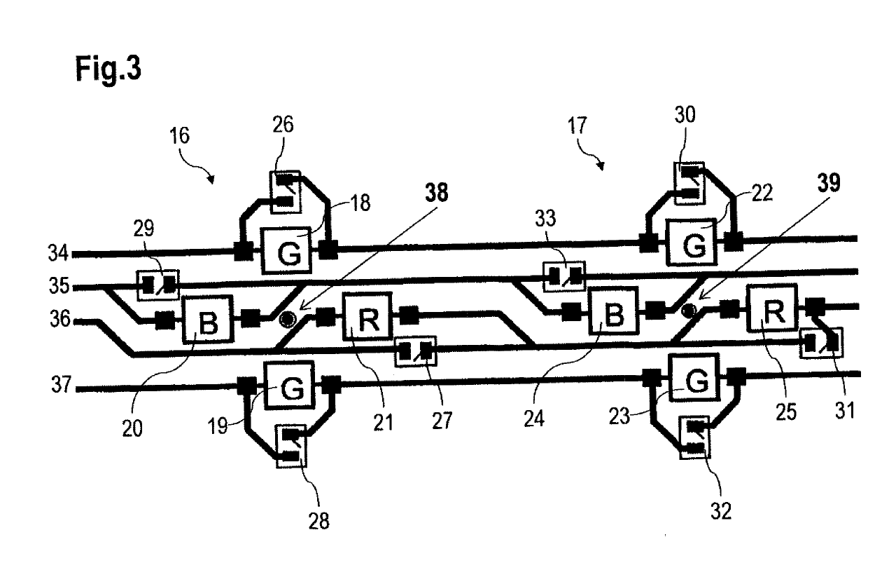

FIG. 3 shows the LED clusters from FIG. 2 with additional photosensors;

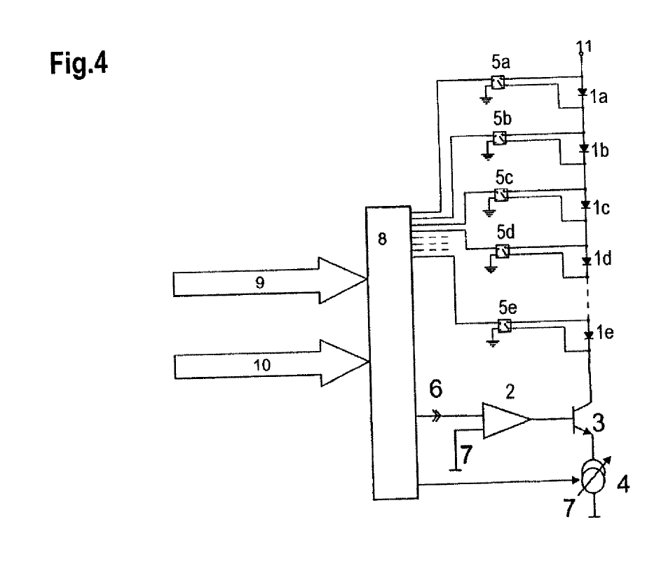

FIG. 4 shows a circuit arrangement comprising a combined regulation composed of pulse width modulation and (DC) current regulation for a plurality of luminous means connected in series.

In accordance with the present approach, in particular an illumination unit, e.g. a back light unit (BLU) for an LCD television for reproducing a video image, is specified. For this purpose, the back light unit can have a multiplicity of light emitting diodes (LEDs) which are arranged on one or a plurality of substrates, preferably in clusters in areal fashion. Furthermore, provision can be made of a multiplicity of dimming devices and also a control unit (control electronics) for driving the dimming devices, in order to regulate the brightness of individual LEDs or individual clusters of LEDs.

The multiplicity of dimming devices (or a subset thereof) can, at least in part, be part of the control unit or be embodied separately from the latter.

The control unit preferably regulates the brightness, e.g. by means of the dimming devices, in a manner dependent on the video image, in particular in a manner dependent on the brightness of the video image, in such a way that energy-efficient operation, e.g. of the LCD display or of the television comprising the LCD display, is made possible. In this case, darker regions of the image are illuminated more weakly than brighter regions of the image with the aid of the illumination unit.

Consequently, the solution presented here efficiently enables a significant energy saving in such a way that an unnecessary power consumption is avoided by means of the setting of the illumination, in particular the back light illumination of an LCD display.

Another advantage consists in the fact that it is possible to set any desired colors or color loci for the backlighting by using LEDs having different wavelengths.

The control unit, in particular, the dimming devices, can have one or a plurality of PWM circuits which can be used to carry out a respective pulse width modulation for an (individual) LED or for a group of LEDs comprising one or a plurality of LED clusters. It is advantageous if LEDs can be driven individually and/or in groups or clusters by means of dedicated pulse width modulation. Consequently, the brightness of an individual LED and/or of an LED cluster can be set in a spatially resolved manner. It should be noted here that the LEDs and/or LED clusters are advantageously provided at (different) positions of the image, such that specific positions of the image can be backlit more strongly or more weakly by means of the corresponding driving of the (brightnesses of the) LEDs or of the LED clusters.

One option in the approach presented here consists in the fact that a combination of PWM regulation and (DC) current regulation is used for setting the brightness of the luminous means (LEDs, clusters of LEDs). In this case, in an advantageous manner, dimming in a bright range is predominantly realized with the aid of the PWM regulation, while the DC current regulation is preferably used in a range of low brightness.

Furthermore, the dimming device can have a multiplicity of switches which make it possible to short-circuit individual LEDs or LED clusters, whereby the affected LEDs or LED clusters are switched off. In such a case, the LCD backlighting is achieved by means of the remaining (not short-circuited) LEDs or LED clusters.

Said switches can be operated dynamically, that is to say in a manner dependent on the currently displayed image, that is to say in a manner dependent on a video signal displayed by means of the LCD display. As an alternative, the switches can be preset in a static manner, e.g. be set during the configuration of a television, in which case, by way of example, values for brightness, contrast, color contrast, etc. are preset in a quasi-static manner by the user or the manufacturer.

The use of switches can be advantageous particularly when the PWM regulation encounters its limits for low brightnesses. The remaining active (that is to say not short-circuited) LEDs can thus be operated in a higher brightness range in which the PWM regulation is possible without any problems.

In a further embodiment, the back light unit has at least one photosensor which can be used to detect a local illumination state (brightness, color temperature, and/or individual color intensities). The at least one photosensor is advantageously arranged in such a way that at least one electrical output signal of the photosensor is communicated to the control unit via at least one sense line for evaluation.

In an advantageous manner, a plurality of photosensors are arranged in a manner distributed over an area of the illumination unit, such that a plurality of illumination states can be detected at different locations of the image. This enables local illumination states of the illumination unit to be controlled reliably and with high accuracy.

In an additional embodiment, at least two LEDs of different clusters are connected in series and are operated by means of a common driver (driver stage). As a result, it is possible to significantly simplify the control unit since, in an advantageous manner, only a small number of drivers have to be provided for the illumination unit.

In particular, both the drivers and the switches can be driven by a common control unit (also see FIG. 4).

In one embodiment, diffusely scattering barriers arranged perpendicularly to the mounting area of the luminous means are provided in order advantageously to separate the regions of different illumination.

FIG. 1 shows a block diagram of an illumination unit, in particular a back light unit (BLU).

The illumination unit comprises an image 15, corresponding e.g. to a video image displayed by means of an LCD display of a television. Further forms of display of the image 15 are also possible, for example by means of projection and/or back projection.

Luminous means 13 are provided for illuminating or backlighting the image 15. Preferably, a plurality of luminous means 13 are arranged such that they are locally distributed over the area of the image 15, wherein this plurality of luminous means 13 can be combined in clusters each composed of a plurality of luminous means. The clusters preferably form individually drivable units.

Light emitting diodes (LEDs) are particularly suitable for use as luminous means 13. In particular, a plurality of LEDs having different wavelengths can be arranged in a cluster. The color of the backlighting can be set by means of the mixture of the wavelengths. Preferably, one red, two green and one blue LED can be locally combined in a cluster (so-called “RGGB” cluster).

FIG. 1 additionally shows a detection unit 14, which can be used to detect, in particular, a locally distributed brightness of the image 15. For this purpose, provision can be made of a plurality of sensors, in particular photosensors, which are arranged locally at a plurality of locations of the areal image 15. One possibility consists in arranging at least one photosensor together with each cluster of luminous means.

The luminous means 13 and the detection unit 14 are merely indicated symbolically in FIG. 1. As explained, luminous means 13 and detection unit 14 preferably include a plurality of units or components which, in particular, are arranged in a manner distributed over the area of the image 15.

Furthermore, a control unit 12 is provided, which evaluates signals of the detection unit 14 and correspondingly drives the luminous means 13, e.g. the plurality of clusters of LEDs distributed locally over the area of the image 15. In particular, the control unit 12 has at least one dimming device which can be used to set a brightness of the at least one luminous means 13 or each LED or each cluster of LEDs. The dimming device can also be arranged separately from the control unit 12. In particular, it is possible for at least one portion of the dimming device to be arranged on the cluster of LEDs. In particular, a multiplicity of dimming devices are provided in this case.

The dimming device can set the brightnesses of the luminous means, in particular of each LED or each cluster of LEDs, by means of pulse width modulation (PWM) and/or by means of DC current regulation.

FIG. 2 shows two adjacent LED clusters 16 and 17 (“RGGB” clusters), wherein the first cluster 16 has two green LEDs 18, 19, one blue LED 20 and one red LED 21. The second LED cluster 17 comprises two green LEDs 22, 23, one blue LED 24 and one red LED 25. Furthermore, supply lines 34 to 37 are provided, wherein the green LEDs 18 and 22 are connected to the supply line 34, the blue LEDs 20 and 24 are connected to the supply line 35, the red LEDs 21 and 25 are connected to the supply line 36, and the green LEDs 19 and 23 are connected to the supply line 37.

Switches 26 to 33 are shown, with the aid of which each of the LEDs 18 to 25 can respectively be bridged, that is to say short-circuited. The switches are preferably embodied as electronic switches which can be activated with the aid of the control unit 12. Control lines to the switches are not illustrated separately in FIG. 2.

FIG. 3 largely corresponds to the illustration from FIG. 2, supplemented by photosensors 38 and 39. The photosensors 38 and 39 are preferably arranged in a region around the center of the LED cluster 16 and 17 in cutouts provided, in such a way that the light-sensitive area of the sensors is arranged on the front side of the illumination unit and the sense lines (not shown in the figure) are substantially arranged on the rear side.

FIG. 4 shows a circuit arrangement including a combined regulation composed of pulse width modulation and (DC) current regulation for a plurality of luminous means connected in series.

FIG. 4 includes a control unit 8, which acquires an image, e.g. a video signal 9, and also brightness information 10, e.g. by means of at least one photosensor. The control unit 8 is connected to a PWM switch 3 via an operational amplifier 2 via a PWM signal line 6. Furthermore, the control unit 8 influences a current regulator 4. The combination of PWM regulation 3 and 6 and current regulator 4 serves for the brightness driving of the series-connected LEDs 1a to 1e. Each LED 1a to 1e can be short-circuited by means of the control unit 8 with the aid of a switch 5a to 5e.

Consequently, the approach presented here enables an illumination unit, e.g. a back light illumination, which comprises the LEDs 1a to 1e, in particular, to be driven in a manner dependent on the video signal 9 and the brightness information 10 in such a way that the brightness of the LEDs 1a to 1e is set in a suitable manner by means of the pulse width modulation 6, 2, 3 and/or the DC current regulation 4.

### LIST OF REFERENCE SYMBOLS

1a-1e LED
2 Operational amplifier
3 PWM switch
4 Current regulator
5a-5e LED switch
6 PWM signal line
7 Ground
8 Control unit
9 Video signal
10 Brightness information
11 Supply voltage
12 Control unit
13 (at least one) Luminous means
14 (at least one) Detection unit
15 Image (video image)
16 LED cluster
17 LED cluster
18 Green LED
19 Green LED
20 Blue LED
21 Red LED
22 Green LED
23 Green LED
24 Blue LED
25 Red LED
26-33 Switch
34-37 Supply line
38 Photosensor
39 Photosensor

1. An illumination unit, comprising:
at least one luminous means;
a detector, which is configured to be used to detect at least one brightness of an image;
at least one controller connected to the at least one luminous means and to the detector, wherein the at least one luminous means can be driven in a manner dependent on the at least one brightness of the image with the aid of the controller;
a plurality of luminous means whose brightnesses can be set in each case at least one of individually and in clusters with the aid of the controller; and
at least one switch is configured to be used to short-circuit at least one luminous means.

2. (canceled)

3. (canceled)

4. (canceled)

5. (canceled)

6. (canceled)

7. The illumination unit as claimed claim 1,
wherein the controller comprises at least one dimming device.

8. (canceled)

9. (canceled)

10. (canceled)

11. The illumination unit as claimed in claim 1,
wherein the controller is configured to illuminate dark regions of the image more weakly than bright regions with the aid of the detector by means of the at least one luminous means.

12. The illumination unit as claimed in claim 1,
wherein the at least one luminous means comprises light emitting diodes having different wavelengths.

13. The illumination unit as claimed in claim 1,
wherein brightnesses of the image can be set with the aid of the controller by means of at least one of a pulse width modulation and a DC current regulation.

14. The illumination unit as claimed in claim 13,
wherein the brightness of the at least one luminous means can be set by means of at least one of the pulse width modulation and the DC current regulation.

15. The illumination unit as claimed in claim 13,
wherein the DC current regulation can be used in a range of low brightness.

16. The illumination unit as claimed in claim 13,
wherein the pulse width modulation can be used in a range of high brightness.

17. (canceled)

18. (canceled)

19. (canceled)

20. (canceled)

21. The illumination unit as claimed in claim 1,
wherein barriers are provided between the image and the detector, said barriers being suitable for at least partly separating regions of different illumination.

22. The illumination unit as claimed in claim 1,
wherein the controller is configured to acquire a video signal.

23. (canceled)

24. A method for driving an illumination unit, the method comprising:
detecting a brightness of an image;
driving at least one luminous means on the basis of the detected brightness, wherein at least one dark region of the image is illuminated more weakly than at least one bright region of the image with the aid of the at least one luminous means;
wherein provision is made of at least one switch which is used to short-circuit at least one luminous means.

25. (canceled)

26. (canceled)

27. (canceled)

28. (canceled)

29. The method as claimed in claim 24, wherein provision is made of a plurality of luminous means whose brightnesses is/are set at least one of individually and in clusters with the aid of a controller.

30. The method as claimed in claim 24, wherein the brightness of the at least one luminous means is set by means of at least one of a pulse width modulation and a DC current regulation.

31. The method as claimed in claim 24, wherein the DC current regulation is used in a range of low brightness.

32. (canceled)

33. The method as claimed in claim 24, wherein a video signal is applied to a controller.

34. The method as claimed in claim 24, wherein the pulse width modulation is used in a range of high brightness.
